(19) United States
(12) Patent Application Publication
(10) Pub. No.: US 2009/0010267 A1
(43) Pub. Date: Jan. 8, 2009

(54) NETWORK DEVICE AND PACKET FORWARDING METHOD THEREOF

(75) Inventors: Yu-Cheng Lin, Tu-Cheng (TW); Meng-Shu Lee, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/036,278

(22) Filed: Feb. 24, 2008

(30) Foreign Application Priority Data
Jul. 4, 2007 (CN) 200710200996.0

(51) Int. Cl. H04L 12/56

(52) U.S. Cl. 370/397

(57) ABSTRACT

A network device, for forwarding packets from an asynchronous transmit mode (ATM) network over different permanent virtual connections (PVC) to a plurality of terminal devices, includes a storage module, a flag setting module, a buffer, and a sending module. The storage module is for storing an identifier of at least one predetermined PVC, and packets transmitted over the at least one predetermined PVC need to be processed with higher priority. The flag setting module is for receiving the packets transmitted over the different PVCs, marking packets transmitted over the at least one predetermined PVC corresponding to the identifier stored in the storage module, and sending the packets to the buffer for temporarily storing the packets. The sending module is for retrieving the packets from the buffer, and first sending the marked packets to the plurality of terminal devices.

### BACKGROUND OF THE INVENTION

1. Field of the Invention

The invention relates to network devices, and particularly to a network device and packet forwarding method for the network device.

2. Description of Related Art

In a communication system concerning an asynchronous transmit mode (ATM) network, a network device is connected to the ATM network over a plurality of permanent virtual connections (PVC) for forwarding data with different priority levels from the ATM network to a plurality of terminal devices. The network device receives data transmitted over different PVCs, determines priority levels of the data according to IP QoS mechanism provided by Internet service providers (ISPs), and sends the data according to the priority levels thereof.

In practice, not all the ISPs provide the IP QoS mechanism. Even if all the ISPs provide the IP QoS mechanism, the IP QoS mechanisms provided by various ISPs may be different. Thus, data transmitted over different PVCs from the ATM network may not be timely forwarded to the plurality of network devices according to priority levels thereof, which would bring inconvenience to users of the plurality of terminal devices.

### SUMMARY OF THE INVENTION

In one aspect of the invention, a network device for forwarding packets from an asynchronous transmit mode (ATM) network over different permanent virtual connections (PVC) to a plurality of terminal devices is provided. The network device includes a storage module, a flag setting module, a buffer, and a sending module. The storage module is for storing an identifier of at least one predetermined PVC, and packets from the at least one predetermined PVC need to be processed with higher priority. The flag setting module is for receiving the packets transmitted over the different PVCs, marking packets from the at least one predetermined PVC corresponding to the identifier stored in the storage module, and sending the packets. The buffer is for temporarily storing the packets sent by the flag setting module. The sending module is for retrieving the packets from the buffer, and first sending the marked packets to the plurality of terminal devices. A packet forwarding method of a network device is also provided.

Other advantages and novel features will become more apparent from the following detailed description when taken in conjunction with the accompanying drawings.

### BRIEF DESCRIPTION OF THE DRAWINGS

FIG. 1 is a schematic diagram of a network device of an exemplary embodiment of the invention.

FIG. 2 is a schematic diagram of packet forwarding flow of another exemplary embodiment of the invention.

FIG. 3 is a flowchart of a packet forwarding method of a further exemplary embodiment of the invention.

FIG. 4 is a flowchart of a packet forwarding method of another further exemplary embodiment of the invention.

### DETAILED DESCRIPTION OF THE INVENTION

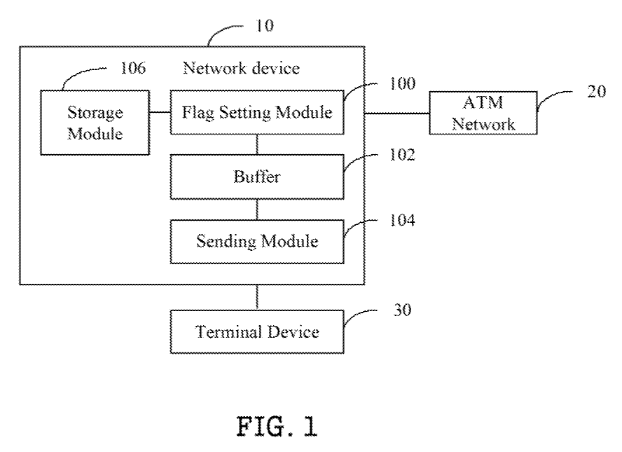

FIG. 1 is a schematic diagram of a network device 10 of an exemplary embodiment of the invention. The network device 10 forwards packets from an asynchronous transmit mode (ATM) over different permanent virtual connections (PVC) to a plurality of terminal devices 30 (only one shown). In the exemplary embodiment, the network device 10 may be a modem or a router, and the terminal devices 30 may be personal computers.

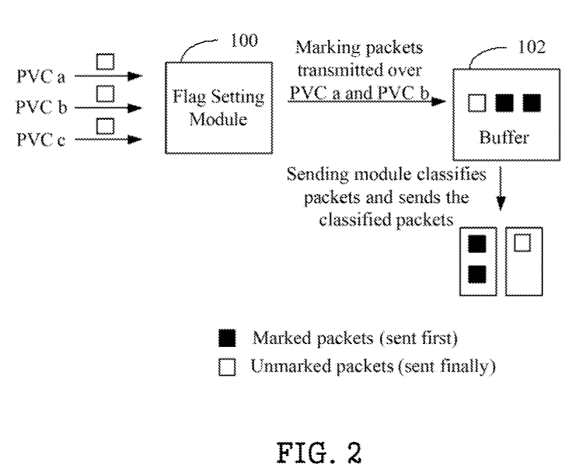

In the exemplary embodiment, the network device 10 includes a flag setting module 100, a buffer 102, a sending module 104, and a storage module 106. The storage module 106 is used for storing an identifier of at least one predetermined PVC, and packets transmitted over the at least one predetermined PVC need to be processed with higher priority. In the exemplary embodiment, the at least one predetermined PVC is preset by users. For example, as shown in FIG. 2, there are three PVCs a, b, c between the network device 10 and the ATM network 20, if a user predetermines that packets transmitted over the PVC a and the PVC b need to be processed first, the storage module 106 stores PVC a and PVC b. In alternative embodiments, the storage module 106 may store identifiers of PVCs with lower priority.

The flag setting module 100 is used for receiving packets transmitted over different PVCs, marking packets transmitted over the at least one predetermined PVC corresponding to the identifier stored in the storage module 106, and sending the packets including the marked packets and unmarked packets to the buffer 102. As shown in FIG. 2, the flag setting module 100 receives packets transmitted over the PVCs a, b, c, searches the storage module 106 for the identifier stored therein, that is, the PVC a and the PVC b, then the flag setting module 100 marks packets transmitted over the PVC a and the PVC b by adding tag information to the packets transmitted over the PVC a and the PVC b, and sends all the packets including the marked packets transmitted over the PVC a and the PVC b and unmarked packets transmitted over the PVC c to the buffer 102. In the exemplary embodiment, the flag setting module 100 may be an ATM driver. The buffer 102 is used for temporarily storing the packets from the flag setting module 100.

The sending module 104 is used for retrieving the packets from the buffer 102 and sending the marked packets first to the network devices 30. In the exemplary embodiment, the sending module 104 classifies the packets into the marked packets and the unmarked packets according to whether the packets include the tag information (reference to FIG. 2), and sends the classified packets to the network devices 30 according to priority levels of the classified packets. The marked packets with higher priority are sent first by the sending module 104, that is, the packets transmitted over the PVC a and the PVC b are sent first. In the exemplary embodiment, the sending module 104 may be a wireless local area network driver. In alternative embodiments, the marked packets are with lower priority, and the unmarked packets are with higher priority and are sent first by the sending module 104.

In another embodiment of the invention, the storage module 106 is further used for storing priority levels of the at least one predetermined PVC. Still reference to FIG. 2, if the user predetermine that the packets transmitted over the PVC a need to be processed with the highest priority and the packets transmitted over the PVC b need to be processed with higher priority, the storage module 106 stores PVC a and a priority A thereof and PVC b and a priority B thereof. The sending module 104 classifies the packets into the marked packets and the unmarked packets, and then classifies the marked packets according to the priority levels of the at least one predetermined PVC. The marked packets with the highest priority are sent first, that is, the sending module 104 first sends the packets transmitted over the PVC a, then sends the packets transmitted over the PVC b, and finally sends the packets transmitted over the PVC c.

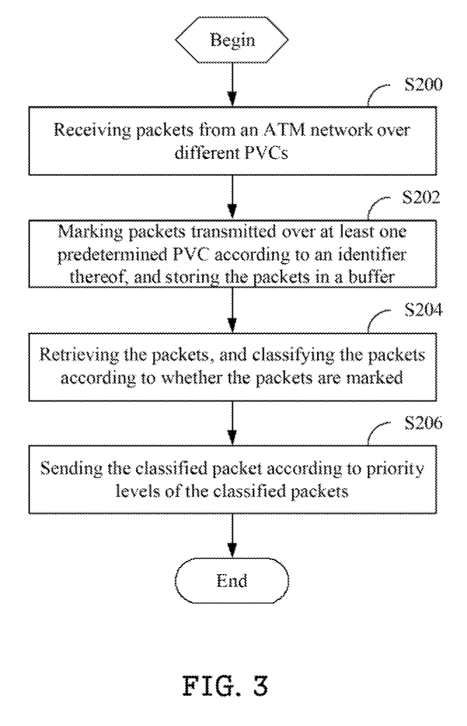

FIG. 3 is a flowchart of a packet forwarding method of the network device 10 of an exemplary embodiment of the invention. In step S200, the flag setting module 100 receives packets transmitted over different PVCs from the ATM network 20. In step S202, the flag setting module 100 marks packets transmitted over the at least one predetermined PVC according to the identifier of the at least one predetermined PVC stored in the storage module 106, and temporarily stores the packets in the buffer 102. In the exemplary embodiment, the flag setting module 100 marks the packets transmitted over the at least one predetermined PVC by adding tag information to the packets thereof. In step S204, the sending module 104 retrieves the packets from the buffer 102, and classifies the packets according to whether the packets are marked. In step S206, the sending module 104 sends the classified packets to the network device 30 according to priority levels of the classified packets. In the exemplary embodiment, the sending module 104 classifies the packets into marked packets with higher priority and unmarked packets with lower priority, first sends the marked packets, and finally sends the unmarked packets.

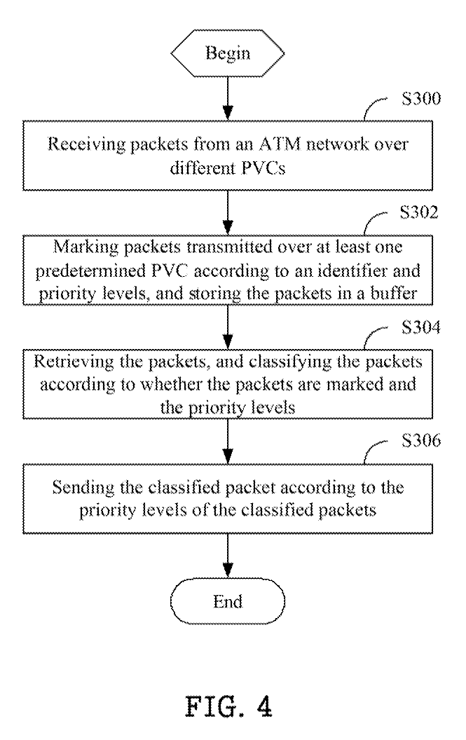

FIG. 4 is a flowchart of a packet forwarding method of the network device 10 of another exemplary embodiment of the invention. In step S300, the flag setting module 100 receives packets transmitted over different PVCs from the ATM network 20. In step S302, the flag setting module 100 marks packets transmitted over the at least one predetermined PVC according to the identifier and the priority levels of the at least one predetermined PVC stored in a storage module 106, and temporarily stores the packets in the buffer 102. In step S304, the sending module 104 retrieves the packets from the buffer 102, and classifies the packets according to whether the packets are marked and the corresponding priority levels. In step S306, the sending module 104 sends the classified packets to the network device 30 according to the priority levels of the classified packets. In the exemplary embodiment, the sending module 104 first classifies the packets into marked packets and unmarked packets, then classifies the marked packets according to the priority levels of the at least one predetermined PVC. The sending module 104 first sends the marked packets with the highest priority level, then sends the marked packets with the next priority level, and finally sends the unmarked packets.

The network device 10 and the packet forwarding method thereof can efficiently classify packets, and send time sensitive packets with higher priority.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A network device, for forwarding packets received from an asynchronous transmit mode (ATM) network over different permanent virtual connections (PVC) to a plurality of terminal devices, comprising:
a storage module, for storing an identifier of at least one predetermined PVC, wherein a packet transmitted over the at least one predetermined PVC needs to be processed with higher priority;
a flag setting module, for receiving the packets transmitted over the different PVCs, and marking packets transmitted over the at least one predetermined PVC corresponding to the identifier stored in the storage module, and sending the packets;
a buffer, for temporarily storing the packets sent by the flag setting module; and
a sending module, for retrieving the packets from the buffer, and first sending the marked packets to the plurality of terminal devices.

2. The network device of claim 1, wherein the flag setting module comprises an ATM driver.

3. The network device of claim 1, wherein the flag setting module marks the packets transmitted over the at least one predetermined PVC by adding tag information to the packets transmitted over the at least one predetermined PVC.

4. The network device of claim 3, wherein the sending module is further used for classifying the packets into the marked packets and unmarked packets according to whether the packets from the buffer comprise the tag information.

5. The network device of claim 1, wherein the sending module comprises a wireless local area network driver.

6. The network device of claim 1, wherein the storage module is further used for storing priority levels of the at least one predetermined PVC.

7. The network device of claim 6, wherein the sending module is further used for classifying the packets into the marked packets and unmarked packets and classifying the packets according to the priority levels of the at least one predetermined PVC.

8. The network device of claim 7, wherein the sending module is further used for sending the marked packets according to the priority levels thereof first, then sending the unmarked packets.

9. A packet forwarding method of a network device, comprising:
receiving packets from an asynchronous transmit mode (ATM) network over different permanent virtual connections (PVCs);
marking packets transmitted over at least one predetermined PVC according to an identifier of the at least one predetermined PVC stored in a storage module, and temporarily storing all the packets in a buffer, wherein the packets transmitted over the at least one predetermined PVC need to be processed with higher priority;
retrieving all the packets from the buffer;
classifying all the packets according to whether the packets are marked; and
sending the classified packets to a plurality of terminal devices according to priority levels of the classified packets.

10. The packet forwarding method of claim 9, wherein the step of marking packets transmitted over the at least one predetermined PVC comprises steps of:
adding tag information to the packets transmitted over the at least one predetermined PVC to mark the packets transmitted over the at least one predetermined PVC.

11. The packet forwarding method of claim 10, wherein the step of classifying all the packets according to whether the packets are marked comprises steps of:
classifying the packets into marked packets and unmarked packets according to whether the packets comprise the tag information.

12. The packet forwarding method of claim 11, wherein the step of sending the classified packets to a plurality of terminal devices according to priority levels of the classified packets comprises steps of:
first sending the marked packets to the plurality of terminal devices; and
then sending the unmarked packets to the plurality of terminal devices.

13. The packet forwarding method of claim 10, wherein the step of marking packets from the at least one predetermined PVC according to an identifier of the at least one predetermined PVC stored in a storage module comprises steps of:
marking the packets from the at least one predetermined PVC according to the identifier and priority levels thereof.

14. The packet forwarding method of claim 13, wherein the step of classifying all the packets according to whether the packets are marked comprises steps of:
classifying the packets into the marked packets and unmarked packets according to whether the packets comprise the tag information; and
classifying the marked packets according to the priority level of the at least one predetermined PVCs.

15. The packet forwarding method of claim 14, wherein the step of sending the classified packets to a plurality of terminal devices according to priority levels of the classified packets comprises steps of:
first sending the marked packets with the highest priority levels to the plurality of terminal devices;
then sending the marked packets with the next priority levels to the plurality of terminal devices; and
finally sending the unmarked packets to the plurality of terminal devices.

16. A method for forwarding packets in a network device, comprising:
receiving packets from an asynchronous transmit mode (ATM) network over different permanent virtual connections (PVCs);
selecting at least one predetermined PVC from said different PVCs so that packets transmitted over said at least one predetermined PVC need to be processed with higher priority;
marking said packets transmitted over said at least one predetermined PVC; and
sending said marked packets out prior to unmarked packets from said ATM network over PVCs other than said at least one predetermined PVC.

17. The method of claim 16, further comprising:
adding tag information to said packets transmitted over said at least one predetermined PVC to mark said packets transmitted over said at least one predetermined PVC.
